(19) United States
(12) Patent Application Publication
(10) Pub. No.: US 2023/0174173 A1
(43) Pub. Date: Jun. 8, 2023

(54) SPARE TIRE CAVITY HOSE REEL SYSTEM

(71) Applicant: RMW PARTNERS, LLC, Santaquin, UT (US)

(72) Inventors: Luke Morgan, Santaquin, UT (US); Brandon Wilson, Spanish Fork, UT (US); Miles Renauld, Greenwich, NY (US)

(21) Appl. No.: 18/077,104

(22) Filed: Dec. 7, 2022

Related U.S. Application Data
(60) Provisional application No. 63/287,356, filed on Dec. 8, 2021.

(51) Int. Cl. B62D 43/04

(52) U.S. Cl. CPC B62D 43/045

(57) ABSTRACT

A hose reel system, comprising a housing, a hose reel disposed within the housing, and a bracket receiving element. The bracket receiving element is configured to receive a spare tire mounting bracket. The bracket receiving element is configured to retain the spare tire mounting bracket when tension is applied to a cable associated with the spare tire mounting bracket to secure the hose reel system within a spare tire cavity of a vehicle.

### CROSS-REFERENCE TO RELATED APPLICATIONS

This application claims priority to U.S. Provisional Patent Application No. 63/287,356, filed on Dec. 8, 2021, and entitled “SPARE TIRE CAVITY HOSE REEL SYSTEM”, the entirety of which is incorporated herein by reference.

### BACKGROUND

Various types of construction vehicles are utilized on construction sites, such as excavators, bulldozers, loaders, dump trucks, and/or others. Such construction vehicles are often refueled utilizing a refueling system that is affixed to another vehicle, such as a pickup truck of a construction superintendent, overseer, or foreman. For example, a foreman's pickup truck may include a fuel tank that resides in the truck bed. A pump and hose may be connected to the fuel tank within the truck bed. To refuel a construction vehicle, the hose may be extended over the side of the truck bed toward a fuel inlet of the construction vehicle, and the pump may be activated to facilitate transportation of fuel from the fuel tank to the fuel reservoir of the construction vehicle.

Existing refueling systems that are mountable on pickup trucks suffer from a number of shortcomings. For instance, storing the fuel pump and hose in the truck bed with the fuel tank occupies otherwise usable space of the truck bed. Also, storing the fuel hose in the truck bed can result in a cumbersome refueling process, requiring users to gather the fuel hose from the back of the truck, uncoil the hose, perform the refueling, recoil the hose, and return the hose to the back of the truck. Furthermore, when fuel leaks occur, fuel often spills into the truck bed, which can be aesthetically unappealing, can damage other materials or tools positioned within the truck bed, and/or can render portions of the truck bed unusable until the fuel spill is addressed. Still furthermore, extending the fuel hose over the side of the pickup truck bed can scratch and/or deposit debris on the side of the pickup truck.

For many construction entities, pickup trucks used for refueling construction vehicles are operated by foremen, superintendents, owners, and/or other overseeing/managing individuals. Such individuals often utilize their pickup trucks for other purposes in addition to refueling, such as interfacing with clientele, business partners, investors, suppliers, and/or others. As noted above, existing refueling systems can degrade the aesthetic of pickup trucks (e.g., hose storage and/or fuel spills within the truck bed, scratches and/or debris on the side of the truck, etc.). Thus, when a refueling truck operator uses a pickup truck with a conventional refueling system to interface with customers (or others), the customers' perception of the refueling truck operator (and/or the business entity associated with the refueling truck operator) can be affected by the aesthetic damage wrought upon the pickup truck by the conventional refueling system.

Accordingly, there is an ongoing need and desire for improved refueling systems that can be implemented on pickup trucks.

The subject matter claimed herein is not limited to embodiments that solve any disadvantages or that operate only in environments such as those described above. Rather, this background is only provided to illustrate one exemplary technology area where some embodiments described herein may be practiced.

### BRIEF DESCRIPTION OF THE DRAWINGS

In order to describe the manner in which the advantages and/or features described herein can be obtained, a particular description of the subject matter disclosed herein will be rendered by reference to specific embodiments and/or components, which are illustrated in the appended drawings. Understanding that these drawings depict only example embodiments/components and are not therefore to be considered limiting in scope, embodiments/components will be described and explained with additional specificity and detail through the use of the accompanying drawings in which:

FIG. 1 illustrates an example housing configured to mount within a spare tire cavity of a vehicle.

FIG. 2 illustrates an example bracket receiving element associated with the housing of FIG. 1.

FIG. 3 illustrates another example of a housing configured to mount within a spare tire cavity of a vehicle.

FIG. 4 illustrates an example bottom cover of a housing, in accordance with implementations of the present disclosure.

FIG. 5 illustrates an example flow diagram depicting acts associated with installing a hose reel system within a spare tire cavity of a vehicle.

### DETAILED DESCRIPTION

Disclosed embodiments are generally directed to housings and/or hose reel systems that are mountable within spare tire cavities of vehicles (e.g., pickup trucks). At least some disclosed embodiments are generally directed to a method for mounting a housing and/or hose reel system within a spare tire cavity of a vehicle.

### Examples of Technical Benefits, Improvements, and Practical Applications

Those skilled in the art will recognize, in view of the present disclosure, that at least some of the disclosed embodiments may be implemented to address various shortcomings associated with at least some conventional vehicle-mounted refueling systems. The following section outlines some example improvements and/or practical applications provided by the disclosed embodiments. It will be appreciated, however, that the following are examples only and that the embodiments described herein are in no way limited to the example improvements discussed herein.

Many pickup trucks include after-market wheels, especially those used by construction superintendents, foreman, owners, and the like. In many instances, the spare tire/wheel provided by the pickup truck manufacturer is incompatible with the after-market wheels obtained by the pickup truck owner/operator. Thus, spare tires on pickup trucks are often rendered functionally obsolete and go unused by pickup truck owner/operators.

Spare tires on pickup trucks are typically stored on an underside of the pickup truck within a spare tire cavity, with the spare tire held in place by a spare tire mounting bracket of the pickup truck. Typically, the spare tire mounting bracket is connected to a cable suspended from a middle portion of the spare tire cavity of the pickup truck. The spare tire mounting bracket inserts through the centerbore of the spare tire. After entry through the centerbore of the spare tire, opposing engagement members of the spare tire mounting bracket are brought into contact with the center disc of the spare tire such that, when tension is applied to the cable connected to the spare tire mounting bracket, the spare tire mounting bracket pulls the spare tire into the spare tire cavity and retains the spare tire therein. Tension is typically applied to the cable via a tensioning system of the pickup truck, which is often accessible from a rear of the pickup truck and actuatable utilizing a tool provided with the pickup truck (e.g., a spare tire iron, which may include an end that is insertable into a slot at the rear of the pickup truck, whereupon rotation of the spare tire iron may facilitate actuation of the tensioning system).

In view of the foregoing, in many instances, spare tires on pickup trucks (e.g., pickup trucks used by construction foreman, superintendents, owners, and the like) can be removed to advantageously render the spare tire cavity or space available for other uses.

At least some implementations of the present disclosure include hose reel system configured to reside in spare cavity tire and to be secured therein using the mounting hardware of the truck for securing a spare tire within the cavity. The hose reel system is configured to connect to a reservoir that resides within the truck bed of the reservoir. A hose of the hose reel system may be accessible from the rear of the truck and extendable therefrom. In this way, the hose reel system may facilitate access and/or extraction of fuel from the reservoir of the truck bed without use of a fuel hose that resides within the truck bed and extends over the side of the truck bed. Instead, the fuel can travel to the hose reel system residing within the spare tire cavity, and a hose may extend from the hose reel system from the rear of the truck to facilitate refueling of proximate construction equipment.

By utilizing a hose reel system in accordance with the present disclosure, the unappealing aesthetic of coiled fuel hoses residing within the beds of construction pickup trucks may be avoided. Furthermore, damage and/or soiling of truck bed interiors and/or sides may be at least partially avoided, in particular because the fuel hose need not reside within the truck bed or extend over the side of the truck bed to reach proximate construction equipment for refueling.

Further advantageously, hose reel systems of the present disclosure may be mounted within a pickup truck spare tire cavity utilizing the existing spare tire mounting hardware of the pickup truck (e.g., the spare tire mounting bracket, cable, tensioning system etc.). Thus, in many instances, pickup trucks may receive the disclosed hose reel systems without undergoing significant hardware modifications.

Although the present disclosure focuses, in at least some respects, on hose reel systems that are mountable within spare tire cavities of pickup trucks, embodiments of the present disclosure are not limited thereto. For example, at least some implementations of the present disclosure are directed to a housing that is mountable within a spare tire cavity of a pickup truck via a bracket receiving element of the housing. Such a housing may define an interior space which may store or house any suitable device(s), component(s), tool(s), and/or apparatus(es) (e.g., not limited to hose reels).

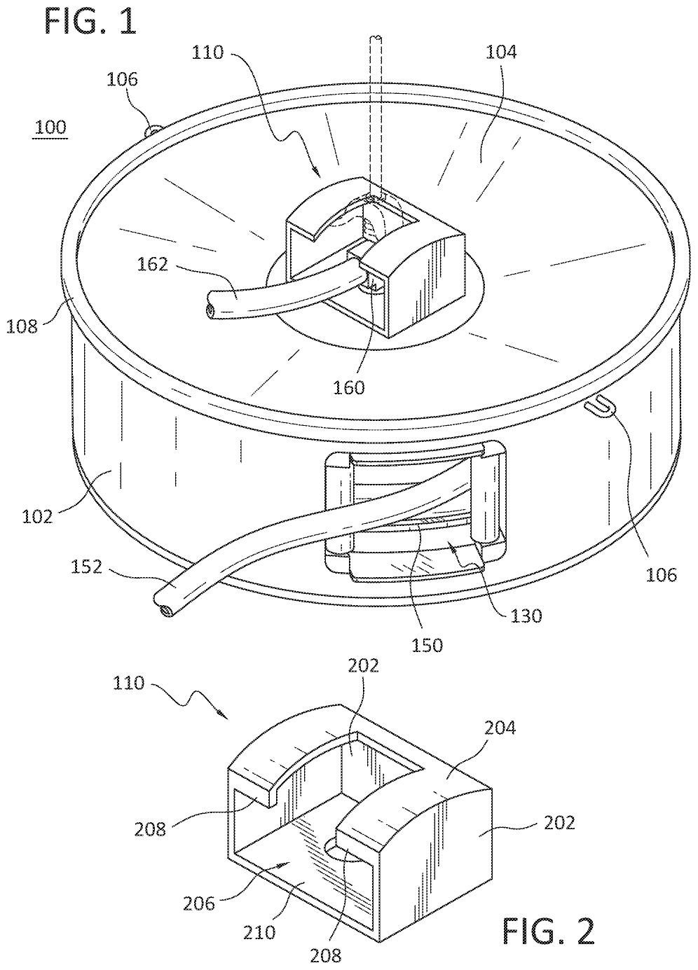

Having just described some of the various high-level features and benefits of the disclosed embodiments, attention will now be directed to FIGS. 1 through 5. These Figures illustrate various components, conceptual representations, and supporting illustrations related to the disclosed embodiments.

### Example Housings and Hose Reel Systems

Attention is now directed to FIG. 1, which illustrates a housing 100, in accordance with implementations of the present disclosure. As is evident from FIG. 1, the housing 100 comprises a substantially cylindrical form factor similar to that of a spare tire of a pickup truck. In this regard, the housing 100 of FIG. 1 is sized and shaped to at least partially fit within a spare tire cavity of a vehicle. For example, in some implementations, the housing 100 comprises a diameter within a range of about 20 inches to about 43 inches and a height within a range of about 8 inches to about 30 inches. Notwithstanding, the housings of the present disclosure are not limited to the example size ranges noted above.

FIG. 1 illustrates that the housing includes a sidewall 102 and a cover 104, which are connected to one another in any suitable fashion (e.g., via welding and/or one or more other attachment mechanisms). The housing 100 may additionally comprise a bottom cover (e.g., see bottom cover 402 of FIG. 4). The sidewall 102 and the cover 104 (and the bottom cover 402, where present) at least partially define and/or enclose a housing body that forms an interior space within the housing 100 (e.g., a substantially cylindrical interior space). As will be described in more detail hereinafter, the interior space defined by the sidewall 102 and the cover 104 may be configured to receive various devices, components, tools, or apparatuses, such as a hose reel.

The housing 100 of FIG. 1 furthermore includes a bracket receiving element 110. The bracket receiving element 110 is configured to receive a spare tire mounting bracket of a vehicle to facilitate mounting of the housing 100 (and any device contained therein, such as a hose reel) at least partially within a spare tire cavity of the vehicle. As noted above, a spare tire mounting bracket is usually connected to a cable suspended from a middle portion of the spare tire cavity of the vehicle. The cable is connected to a tensioning system that allows the spare tire mounting bracket to descend from or ascend toward the underside of the vehicle (e.g., from within the spare tire mounting cavity). In this regard, the bracket receiving element 110 can be configured to receive and retain the spare tire mounting bracket such that, when tension is applied to the cable connected to the spare tire mounting bracket, the housing 100 may ascend into the spare tire cavity and become secured therein.

FIG. 1 illustrates that, in some implementations, a cover 104 of a housing 100 includes a pad 108, which may be configured to intervene between at least a portion of the cover 104 and a bottom surface of a vehicle (e.g., within a spare tire cavity) when the housing 100 is mounted within the spare tire cavity of the vehicle. The pad 108 may comprise a rubberized or other shock-absorbing material to ameliorate transmission of vibrations from the vehicle to the mounted housing.

In some instances, the bracket receiving element 110 is connected or selectively connectable to the cover 104 of the housing 100. For example, in some implementations, where the bracket receiving element 110 is selectively connectable to the cover 104, a user may cause the bracket receiving element to receive the spare tire mounting bracket of a vehicle and subsequently selectively connect the bracket receiving element 110 to the housing 100 (e.g., via removable bolts) prior to operating the tensioning system of the vehicle to cause the spare tire mounting bracket (and housing 100) to ascend into the spare tire cavity. In some implementations, the bracket receiving element 110 is not directly connected to the cover 104 and/or housing 100 and is instead connected a device secured within the housing 100, such as a hose reel.

FIG. 1 further illustrates that the housing 100 may comprise safety hooks 106, which may be configured to receive chains, cables, or other mechanisms to facilitate additional connection with a vehicle. Such additional connections may serve as a failsafe in case the connection between the spare tire mounting bracket and the housing 100 fails for any reason.

FIG. 2 illustrates a close-up view of the bracket receiving element 110 of the housing 100 of FIG. 1. As is evident from FIG. 2, the bracket receiving element 110 may comprise sidewalls 202 and an upper wall 204 that is connected to the sidewalls 202. In some instances, the upper wall 204 of the bracket receiving element 110 facilitates retention of the spare tire mounting bracket by the housing 100. For example, as is further shown in FIG. 2, the bracket receiving element 110 may comprise an opening 206 configured to receive the spare tire mounting bracket. After the opening 206 receives the spare tire mounting bracket, engagement members of the spare tire mounting bracket may contact the interior face of the upper wall 204 as tension is applied to a cable connected to the spare tire mounting bracket. By maintaining contact with the interior face of the upper wall 204, the tension applied may cause the spare tire mounting bracket to lift the bracket receiving element 110 and (housing 100) into the spare tire cavity.

As is shown in FIG. 2, in some instances, the upper wall 204 of the bracket receiving element 110 includes a surface that forms a curved profile. The curved profile may advantageously define a final position for the spare tire mounting bracket when the spare tire mounting bracket is received via the opening 206 and as tension is applied to the cable associated with the spare tire mounting bracket to secure the housing 100 within the spare tire cavity. For example, as tension is applied, the spare tire mounting bracket may shift toward the highest portion of the curved surface of the upper wall 204 of the bracket receiving element 110. Furthermore, in some instances, the upper wall 204 may comprise one or more stop members 208, such as a lip or protrusion that extends downward from a surface of the upper wall 204, to further ensure retention of the spare tire mounting bracket within the bracket receiving element 110 after insertion of the spare tire mounting bracket through the opening 206 and interfacing of the spare tire mounting bracket with the upper wall 204.

In some implementations, as shown in FIG. 2, the opening 206 for receiving the spare tire mounting bracket is at least partially formed by one or more of the sidewalls 202 and the upper wall 204 of the bracket receiving element 110. In some instances, the opening for receiving the spare tire mounting bracket is formed only by the upper wall of the bracket receiving element.

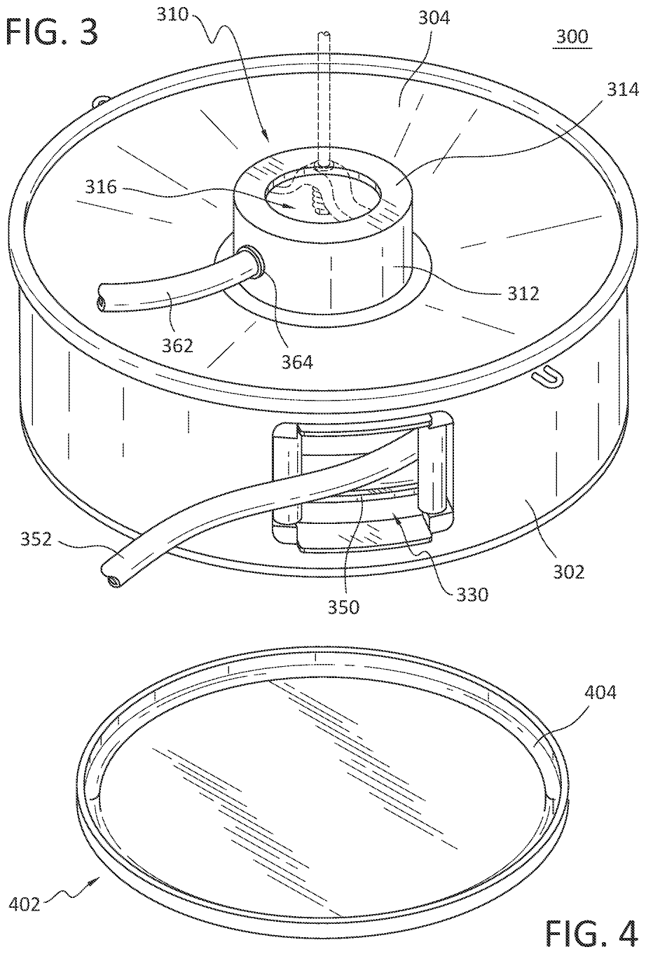

For instance, FIG. 3 illustrates another embodiment of a housing 300, in accordance with the present disclosure. Similar to the housing 100 of FIG. 1, the housing 300 of FIG. 3 includes a sidewall 302, a cover 304, and a bracket receiving element 310. However, in contrast with the bracket receiving element 110 of FIGS. 1 and 2, the bracket receiving element 310 of the housing 300 of FIG. 3 includes a single curved sidewall 312 that forms a substantially cylindrical shape. The upper wall 314 of the bracket receiving element 310 extends radially inward from the curved sidewall 312 such that the bracket receiving element 310 is substantially radially symmetric. The opening 316 of the bracket receiving element is formed by the upper wall 314. In the example of FIG. 3, the opening 316 does not extend to the curved sidewall 312.

The bracket receiving element 310 of the housing 300 may similarly be configured to receive and retain a spare tire mounting bracket of a vehicle. For example, to facilitate entry of the spare tire mounting bracket through the opening 316, the spare tire mounting bracket may be oriented such that the longest dimension of the spare tire mounting bracket (e.g., extending between opposing engagement members of the spare tire mounting bracket) is substantially perpendicular to or otherwise angularly offset from a plane defined by the opening 316. Stated differently, the shortest dimension of the spare tire mounting bracket may be aligned to be substantially parallel with a plane defined by the opening 316 to allow the spare tire mounting bracket to fit through the opening. With such an orientation, the spare tire mounting bracket may be advanced through the opening 316. After entry, the spare tire mounting bracket may be rotated to bring the engagement members of the spare tire mounting bracket into contact with the upper wall 314 of the bracket receiving element 310.

Although the bracket receiving elements 110 and 310 of FIGS. 1 through 3 comprise particular forms, shapes, and/or relative dimensions, these particular features are provided by way of example only and are not limiting of the principles disclosed herein. For example, a bracket receiving element that includes one or more sidewalls, one or more upper walls, and an opening for receiving a spare tire mounting bracket may comprise an elliptical cylindrical shape or other type of cylindrical shape. As yet another example, a bracket receiving element may substantially comprise the shape of any type of polygonal prism. In still other examples, a bracket receiving element may comprise a substantially dome-like shape, where the upper wall and the sidewalls are formed from the same curved surfaces. Yet other shapes/forms of a bracket receiving element are within the scope of the present disclosure.

As noted above, the housings 100 and 300 may be configured to house one or more devices, such as a hose reel. The example housing 100 of FIG. 1 includes a second opening 130, which may be configured to facilitate access to one or more components housed within the housing 100 (the housing 300 as shown in FIG. 3 also includes a second opening 330 similar to the second opening 130 shown in FIG. 1). FIG. 1 furthermore illustrates a rotatable hose reel 150 positioned within the interior space formed by the housing 100 (FIG. 3 also illustrates a hose reel 350 positioned within the interior space formed by the housing 300).

In the example of FIG. 1, a hose 152 of the hose reel 150 is configured to pass through the second opening 130 of the housing 100 to facilitate access to the hose 152 of the hose reel 150 (e.g., to refuel a diesel unit). FIG. 1 also indicates that rollers or brushes may be positioned about the second opening 130 to facilitate smooth extension or retraction of the hose 152 of the hose reel 150 positioned within the housing 100. FIG. 3 similarly illustrates a hose 352 of the hose reel 350 extending through the second opening 330 of the housing 300.

In alternative implementations, a second opening for facilitating access to a device housed by a housing may be positioned on a bottom portion of the housing (e.g., on a bottom cover of the housing).

In some implementations, the hose reel 150, 350 is mounted to an interior of a sidewall 102, 302 of the housing 100, 300. A hose reel 150, 350 may additionally or alternatively be configured to be mounted to any number of other surfaces of a housing 100, 300 (e.g., a cover 104 and/or 304 and/or a bottom cover).

In at least some of the examples discussed above, the bracket receiving elements 110 and 310 of the housings 100 and 300 are mounted directly to the housings 100 and 300, respectively (e.g., to the top covers 104 and 304 of the housings 100 and 300). In contrast, in some instances, the bracket receiving elements 110 and/or 310 may be mounted directly to a hose reel (or other device) mounted within the housings 100 and/or 300, such as hose reels 150 and/or 350. For instance, a bracket receiving element 110 and/or 310 may be mounted directly to a top portion of a hose reel housed within the housings 100 and/or 300. In some instances, to facilitate direct connection between a bracket receiving element and a top portion of a hose reel (or other device), a cover of a housing includes a bracket opening through which the bracket receiving element is configured to extend (e.g., to protrude upward from the hose reel and/or housing).

FIG. 1 illustrates an example swivel connection element 160, which may be connected to the example hose reel 150 of FIG. 1. In some instances, as shown in FIG. 1, the swivel connection element 160 comprises a 90-degree swivel connection element (e.g., to allow for more space for the bracket receiving element to receive the spare tire mounting bracket). The swivel connection element may connect the hose 152 of the hose reel 150 to a supply hose 162. A supply hose 162 of a hose reel 150 configured for use within the housing 100 may be configured to facilitate fluid communication between the hose 152 of the hose reel 150 and a fluid reservoir. The fluid reservoir may comprise a fuel reservoir of a vehicle to which the housing 100 and/or hose reel 150 is/are mounted. For example, the fuel reservoir may reside within a truck bed of a pickup truck, and the supply hose 162 may facilitate fluid communication between the fuel reservoir within the truck bed and the hose 152 of the hose reel 150 within the housing 100. To this end, the supply hose 162 may extend from the housing 100 through one or more gaps formed between the spare tire cavity and the housing 100, and the supply hose 162 may be secured to leaf springs and/or other components on the underside of the pickup truck (with appropriate heat shielding and/or with reasonable distance from the muffler and/or other hot surfaces of the underside of the pickup truck).

To facilitate fluid passage between the fuel reservoir of a vehicle and the hose 152 of the hose reel 150 of the housing 100, the supply hose 162 and/or the swivel connection element 160 may be configured to pass through one or more supply openings on the bracket receiving element 110 and/or on another portion of the housing 100. For instance, the opening 206 (see FIG. 2) of the bracket receiving element 110 may serve as a supply opening through which the supply hose 162 and/or the swivel connection element 160 of the hose reel 150 may extend. One or more additional or alternative supply openings may be formed in the bottom surface 210 of the bracket receiving element 110 (and/or on the cover 104 of the housing 100).

The housing 300 may similarly include a swivel connection element (not shown), supply hose 362, and/or a supply opening to facilitate fluid passage between a fuel reservoir of a vehicle and the hose 352 of the hose reel 350 of the housing 300. In the example of FIG. 3, the supply opening 364 is positioned on the sidewall 312 of the bracket receiving element 310 of the housing 300, and the swivel connection element is at least partially enclosed/surrounded by the bracket receiving element 310 (an additional supply opening may exist in a bottom surface of the bracket receiving element 310 or cover 304, through which the swivel connection element may extend into interfacing with the hose 352 of the hose reel 350).

In alternative implementations, the opening 316 of the bracket receiving element 310 may serve as a supply opening through which the supply hose 362 and/or the swivel connection element of the hose reel 350 may extend. In some instances, a bracket opening of a cover 104, 304 of a housing 100, 300 may be regarded as a supply opening through which a supply hose and/or the swivel connection element may extend.

In addition, or as an alternative, to the foregoing examples, one or more supply openings may be formed on any surface of the bracket receiving element 110, 310 and/or other portions of the housing 100, 300. For instance, a supply opening may additionally or alternatively be formed in a sidewall of a bracket receiving element (e.g., sidewalls 202 and/or 312 of bracket receiving elements 110 and 310, respectively). As another example, a supply opening may be formed in a sidewall of a housing (e.g., sidewalls 102 and/or 302 of housings 100 and/or 300, respectively).

In some instances, only the supply hose extends through a supply opening of the housing and/or bracket receiving element, whereas the swivel connection element does not extend through a supply opening of the housing and/or bracket receiving element. For example, a swivel connection element may be entirely contained within the interior space of the housing 100 and/or 300 (e.g., without extending outward from the housing and/or into the interior space of the bracket receiving element), and the supply hose may extend through one or more supply openings positioned anywhere on the housing 100 and/or 300 and/or the bracket receiving element 110 and/or 310 to reach the swivel connection element.

Conversely, in some instances, only the swivel connection element extends through a supply opening of the housing and/or bracket receiving element, whereas the supply hose does not extend through a supply opening of the housing and/or bracket receiving element. For example, a swivel connection element may extend through a supply opening on a bottom surface of the housing 100 and/or 300 (e.g., on a bottom cover of the housing 100 and/or 300), and the supply hose may connect to the swivel connection element outside of the housing 100 and/or 300 without passing through a supply opening of the housing 100 and/or 300. In such implementations, a protective plate may be affixed to the housing over the swivel connection element and/or the supply hose to prevent damage thereto.

In view of the foregoing, a swivel connection element may be positioned on various portions of a housing 100 and/or 300 or device positioned therein. For example, as noted above, a swivel connection element may be positioned on a bottom surface of the housing 100 and/or 300 (or directly to a bottom of the hose reel positioned within the housing 100 and/or 300). In some implementations, the swivel connection element is positioned on a top portion of the housing 100 and/or 300 (or directly to a top of the hose reel positioned within the housing 100 and/or 300). In some instances, when the swivel connection element is positioned on the top portion of the housing 100 and/or 300 (or directly to the top of the hose reel), at least a portion of the swivel connection element is at least partially surrounded by the sidewall(s) of the bracket receiving element 110 and/or 310. For example, the swivel connection element may be positioned at least partially within an interior space formed by the bracket receiving element 110 and/or 310 to limit the number and/or location of protrusions extending outward from the housing.

In some implementations, the upper wall 204, 314 of the bracket receiving element 110, 310 of the housing 100, 300 is situated offset from (e.g., above) the cover 104, 304 and/or the sidewall 102, 302 of the housing 100, 300. In some implementations, a cover 104, 304 of a housing 100, 300 comprises a concave profile (as shown in FIGS. 1 and 3) such that the one or more sidewalls 202, 312 of the bracket receiving element 110, 310 connect to (or pass through) the cover 104, 304 within the concavity of the cover 104, 304. Such a configuration may allow for the top of the housing 100, 300 to contact an upper surface of a spare tire cavity with a lower ascension height of the spare tire mounting bracket (e.g., as compared to configurations where the cover 104, 304 does not comprise a concavity and where the bracket receiving element 110, 310 does not meet or pass through the cover 104, 304 within the concavity of the cover 104, 304). One will appreciate, in view of the present disclosure, that a cover 104, 304 is not limited to the concave profile shown in FIGS. 1 and 3 and may form any type of depression or descent relative to the top of the sidewall 102, 302 of the housing 100, 300.

As noted above, a housing 100, 300 may comprise a bottom cover 402 (see FIG. 4) positioned opposite the cover 104, 304 relative to the sidewall 102, 302. The bottom cover 402 may, in some instances, comprise a curved or shaped profile. In the example of FIG. 4, the bottom cover 402 defines a channel 404 that extends about the periphery of the bottom cover 402, which may be configured to collect leaked fluids and/or other debris.

A housing and/or components thereof may be formed from any suitable material or combination of materials, such as, by way of non-limiting example, aluminum, steel, combinations/alloys thereof, one or more polymers (e.g., high-density polyethylene) and/or others. In some instances, the thickness of the walls of the housing may be within a range of about ⅛ inch to about ¼ inch, however thicknesses outside of this range are within the scope of the present disclosure. One or more portions of a housing may be coated with any suitable coating, such as, by way of non-limiting example, a rust and/or corrosion preventive/protective coating, a thermal insulation coating (e.g., a BELZONA coating), paint, and/or others.

Hoses discussed herein (e.g., a hose and/or supply hose of a hose reel) may comprise any number of connected hose elements defining a fluid conduit.

In some implementations, a bracket receiving element of a housing (e.g., for at least partially enclosing a hose reel) is implemented as an opening in the top cover of the housing that directly receives a spare tire mounting bracket (e.g., without vertical sidewalls offsetting the bracket receiving opening from the top cover). Stated differently, a bracket opening of a cover (e.g., cover 104, 304) may be regarded as a bracket receiving element in some implementations.

### Example Methods for Installing a Hose Reel System

The following discussion now refers to example methods and method acts that may be performed using systems that include components as disclosed herein. Although the method acts are discussed in a certain order, no particular ordering is required unless specifically stated, or required because an act is dependent on another act being completed prior to the act being performed. One will appreciate that certain embodiments of the present disclosure may omit one or more of the acts described herein.

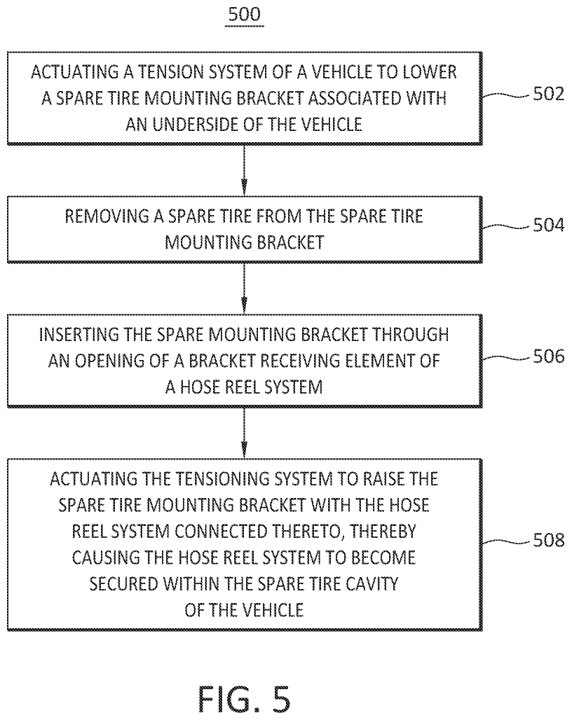

FIG. 5 illustrates an example flow diagram 500 depicting acts associated with installing a hose reel system within a spare tire cavity of a vehicle. Act 502 of flow diagram 500 includes actuating a tensioning system of a vehicle (e.g., a pickup truck) to lower a spare tire mounting bracket associated with an underside of the vehicle. The spare tire mounting bracket may be connected to a cable extending from the tensioning system. The spare tire mounting bracket may be configured to secure a spare tire within a spare tire cavity of the underside of the vehicle.

Act 504 of flow diagram 500 includes removing the spare tire from the spare tire mounting bracket (e.g., where a spare tire is initially secured by the spare tire mounting bracket).

Act 506 of flow diagram 500 includes inserting the spare tire mounting bracket through an opening of a bracket receiving element of a hose reel system (e.g., a hose reel 150, 350 housed by a housing 100 and/or 300, as described herein). The hose reel system may include a housing sized and shaped to fit within the spare tire cavity of the vehicle (e.g., housing 100 and/or 300), a hose reel disposed within the housing (e.g., hose reel 150, 350), and the bracket receiving element (e.g., bracket receiving element 110 and/or 310). The bracket receiving element may include one or more sidewalls (e.g., sidewalls 202 and/or 312), one or more upper walls (e.g., upper walls 204 and/or 314) connected to the one or more sidewalls, and the opening (e.g., openings 206 and/or 316) configured to receive the spare tire mounting bracket.

Act 508 includes actuating the tensioning system to raise the spare tire mounting bracket with the hose reel system connected thereto, thereby causing the hose reel system to become secured within the spare tire cavity of the vehicle.

One will also appreciate that any feature or operation disclosed herein may be combined with any one or combination of the other features and operations disclosed herein. Additionally, the content or feature in any one of the figures may be combined or used in connection with any content or feature used in any of the other figures. In this regard, the content disclosed in any one figure is not mutually exclusive and instead may be combinable with the content from any of the other figures.

Certain terms are used throughout the description and claims to refer to particular methods, features, or components. As those having ordinary skill in the art will appreciate, different persons may refer to the same methods, features, or components by different names. This disclosure does not intend to distinguish between methods, features, or components that differ in name but not function. The figures are not necessarily drawn to scale. Certain features and components herein may be shown in exaggerated scale or in somewhat schematic form and some details of conventional elements may not be shown or described in interest of clarity and conciseness.

Although various example embodiments have been described in detail herein, many modifications are possible in the example embodiments without materially departing from the concepts of present disclosure. Accordingly, any such modifications are intended to be included in the scope of this disclosure. Likewise, while the disclosure herein contains many specifics, these specifics should not be construed as limiting the scope of the disclosure or of any of the appended claims, but merely as providing information pertinent to one or more specific embodiments that may fall within the scope of the disclosure and the appended claims. Any described features from the various embodiments disclosed may be employed in combination. In addition, other embodiments of the present disclosure may also be devised which lie within the scopes of the disclosure and the appended claims. Each addition, deletion, and modification to the embodiments that falls within the meaning and scope of the claims is to be embraced by the claims.

Certain embodiments and features may have been described using a set of numerical upper limits and a set of numerical lower limits. Ranges including the combination of any two values, e.g., the combination of any lower value with any upper value, the combination of any two lower values, and/or the combination of any two upper values are contemplated unless otherwise indicated. Certain lower limits, upper limits and ranges may appear in one or more claims below. Any numerical value is “about” or “approximately” the indicated value, and takes into account experimental error and variations that would be expected by a person having ordinary skill in the art.

The terms first, second, third and the like may be used for distinguishing between similar elements and not necessarily for describing a sequential or chronological order. The terms are interchangeable under appropriate circumstances and the embodiments of the invention can be practiced in sequences other than those described or illustrated herein.

The terms “topmost,” “upper,” “bottommost,” “lower,” “above,” “below,” and the like in the description and in the claims are also used for purposes of example and are not necessarily used to describe relative positions. These terms are interchangeable under appropriate circumstances and the embodiments of the invention described herein can be practiced in other orientations than described or illustrated herein.

In addition, the various embodiments which may be described as “preferred embodiments” are to be construed as merely illustrative of ways and modes for carrying out the invention and not as limitations on the scope of the invention.

The terms “comprising”, “including”, or “having” as used in the claims should not be interpreted as being limited to the means or steps mentioned thereafter. The terms are to be interpreted as specifying the presence of the stated features, elements, steps, or components as referred to, but do not preclude the presence or addition of one or more other features, elements, steps or components, or groups thereof. Thus, the scope of the expression “an apparatus or device comprising means A and B” should not be taken as being limited to an apparatus or device consisting only of components A and B. It is intended that for the purposes of this disclosure, only the parts A and B of the device are specifically mentioned, but the claims should be further construed to include equivalents of these parts.

Any reference herein to singular components or features may additionally or alternatively refer to pluralities of the components or features. Similarly, any reference herein to pluralities of components or features may additionally or alternatively refer to singular components or features.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A hose reel system, comprising:
a housing;
a hose reel disposed within the housing; and
a bracket receiving element, the bracket receiving element being configured to receive a spare tire mounting bracket, the bracket receiving element being configured to retain the spare tire mounting bracket when tension is applied to a cable associated with the spare tire mounting bracket to secure the hose reel system within a spare tire cavity of a vehicle.

2. The hose reel system of claim 1, wherein the bracket receiving element is connected to the housing or to the hose reel.

3. The hose reel system of claim 1, wherein the housing comprises a top cover defining a bracket opening, and wherein the bracket receiving element extends through the opening.

4. The hose reel system of claim 1, wherein the bracket receiving element comprises:
one or more sidewalls;
one or more upper walls connected to the one or more sidewalls; and
an opening configured to receive the spare tire mounting bracket.

5. The hose reel system of claim 4, wherein the opening is defined by the one or more sidewalls or the one or more upper walls of the bracket receiving element.

6. The hose reel system of claim 4, wherein one or more surfaces of the one or more upper walls of the bracket receiving element form a curved profile, the curved profile defining a final position of the spare tire mounting bracket when the spare tire mounting bracket is received via the opening and when tension is applied to the cable associated with the spare tire mounting bracket to secure the housing within the spare tire cavity.

7. The hose reel system of claim 1, wherein the hose reel is mounted to at least one sidewall of the housing.

8. The hose reel system of claim 1, further comprising a second opening through which a hose of the hose reel is configured to pass.

9. The hose reel system of claim 1, further comprising a swivel connection element for connecting a hose of the hose reel to a supply hose, the supply hose being configured to facilitate fluid communication between the hose of the hose reel and a fluid reservoir of the vehicle.

10. The hose reel system of claim 9, wherein the supply hose or the swivel connection element is/are configured to pass through a supply opening in the bracket receiving element or the housing.

11. The hose reel system of claim 9, wherein at least a portion of the swivel connection element is at least partially surrounded by one or more sidewalls of the bracket receiving element.

12. A housing, comprising:
a housing body sized and shaped to fit within a spare tire cavity of a vehicle, the housing body comprising:
at least one sidewall;
at least one cover connected to the at least one sidewall, the at least one sidewall and the at least one cover at least partially defining an interior space; and
a bracket receiving element, the bracket receiving element comprising:
one or more sidewalls connected to the at least one cover of the housing body;
one or more upper walls connected to the one or more sidewalls, the one or more upper walls configured to retain a spare tire mounting bracket when tension is applied to a cable associated with the spare tire mounting bracket to secure the housing within the spare tire cavity of the vehicle; and
an opening configured to receive the spare tire mounting bracket.

13. The housing of claim 12, wherein the bracket receiving element is selectively removable from the at least one cover of housing body.

14. The housing of claim 12, wherein the at least one cover comprises a concave profile such that the one or more sidewalls of the bracket receiving element connect to the at least one cover within a concavity of the at least one cover.

15. The housing of claim 12, further comprising a hose reel configured to reside within a space defined by the housing body.

16. The housing of claim 15, further comprising a swivel connection element for connecting a hose of the hose reel to a supply hose, the supply hose being configured to facilitate fluid communication between the hose of the hose reel and a fluid reservoir of the vehicle.

17. The housing of claim 12, wherein the housing body further comprises a bottom cover.

18. The housing of claim 17, wherein the bottom cover defines a channel about a periphery of the bottom cover.

19. The housing of claim 17, wherein the bottom cover comprises a concave profile.

20. A method for installing a hose reel system within a spare tire cavity of a vehicle, the method comprising:
actuating a tensioning system of a vehicle to lower a spare tire mounting bracket associated with an underside of the vehicle, the spare tire mounting bracket being connected to a cable extending from the tensioning system, the spare tire mounting bracket being configured to secure a spare tire within a spare tire cavity of the underside of the vehicle;
inserting the spare tire mounting bracket through an opening of a bracket receiving element of a hose reel system, the hose reel system comprising:
a housing sized and shaped to fit within the spare tire cavity of the vehicle;
a hose reel disposed within the housing; and
the bracket receiving element, the bracket receiving element comprising:
one or more sidewalls;
one or more upper walls connected to the one or more sidewalls; and
the opening configured to receive the spare tire mounting bracket; and
actuating the tensioning system to raise the spare tire mounting bracket with the hose reel system connected thereto, thereby causing the hose reel system to become secured within the spare tire cavity of the vehicle.
